(19) United States
(12) Patent Application Publication
(10) Pub. No.: US 2026/0011119 A1
(43) Pub. Date: Jan. 8, 2026

(54) NEURAL NETWORK-BASED MEDICAL IMAGE PROCESSING APPARATUS AND METHOD

(71) Applicants: UIF (UNIVERSITY INDUSTRY FOUNDATION), YONSEI UNIVERSITY, Seoul (KR); DONGGUK UNIVERSITY INDUSTRY-ACADEMIC COOPERATION FOUNDATION, Seoul (KR); INTROMEDIC CO., LTD., Seoul (KR)

(72) Inventors: Hong Young JEONG, Incheon (KR); Yun Jeong LIM, Goyang-si (KR); Tae Joon EO, Seoul (KR); Do Sik HWANG, Seoul (KR); Geon Hui SON, Seoul (KR); Ye Jee SHIN, Seoul (KR); Hyeong Seop RHA, Seoul (KR); Ji Woong AN, Yongin-si (KR)

(21) Appl. No.: 18/992,843

(22) PCT Filed: Oct. 31, 2022
(86) PCT No.: PCT/KR2022/016819

§ 371 Date: Jan. 9, 2025

(30) Foreign Application Priority Data
Jul. 21, 2022 (KR) 10-2022-0090390

(51) Int. Cl. G06V 10/764; G06V 10/774; G06V 10/776; G06V 10/82

(52) U.S. Cl. CPC G06V 10/764; G06V 10/774; G06V 10/776; G06V 10/82; G06V 2201/031

(57) ABSTRACT

A neural network-based medical image processing apparatus according to the present invention, which identifies a small intestine region from a medical image acquired by a capsule endoscope, comprises: a memory equipped with an organ identification algorithm for performing organ identification from the medical image; and a processor for applying the medical image to the organ identification algorithm such that the small intestine region is identified. The organ identification algorithm includes: a convolutional neural network algorithm for identifying an organ included in the medical image as the stomach, the small intestine, and the large intestine to identify the small intestine region therefrom; and a temporal filtering algorithm linked to the convolutional neural network algorithm to reduce images which may be misidentified by the convolutional neural network algorithm.

### CROSS-REFERENCE TO RELATED APPLICATIONS

This application is the National Stage filing under 35 U.S.C. 371 of International Application No. PCT/KR2022/016819, filed on Oct. 31, 2022, which claims the benefit of Korean Patent Application No. 10-2022-0090390, filed on Jul. 21, 2022, the contents of which are all hereby incorporated by reference herein in their entirety.

### Technical Field

The disclosure relates to an apparatus and method for processing a medical image based on a neural network, and more particularly to an apparatus and method for processing a medical image based on a neural network, which classify organs in an internal medical image acquired by a capsule endoscope.

### Background Art

In general, capsule endoscopy is used to diagnose various small bowel diseases. In the diagnosis of small bowel diseases, organ classification is required to distinguish a small bowel region in an internal medical image captured by the capsule endoscopy.

Such organ classification technology for the medical image has already been disclosed in Korean Patent No. 10-2237198, titled “AI-BASED INTERPRETATION SERVICE SYSTEM OF MEDICAL IMAGE” and published on Apr. 1, 2021. In this technology, the organ classification is performed based on a classification model with respect to a medical image to be read including a plurality of organs.

Meanwhile, a capsule endoscope sails inside a body for 8 to 12 hours, taking dozens of still images per second to acquire the internal medical image. In the case of the digestive tract, more than about 50,000 still images are taken. Therefore, a clinician needs to read numerous still images in the diagnosis of the small bowel diseases.

However, it is boring to read a large number of still images, and thus an error may occur in a diagnosis result. Accordingly, research and development are being conducted to use artificial intelligence and neural network algorithms for distinguishing a small bowel region. Most related arts are to distinguish the organs in a single image, and it is thus very difficult to figure out a frame where the organs change in the image. Nevertheless, the actual clinical setting uses the image to make a diagnosis. As such, a problem arises in that the small bowel region classified based on the single image is less useful in the diagnosis of small bowel diseases.

### Disclosure

### Technical Problem

An aspect of the disclosure is to provide an apparatus and method for processing a medical image based on a neural network, in which organ changing frames is predicted from images, thereby selectively acquiring images of a small bowel region.

### Technical Solution

According to an embodiment of the disclosure, an apparatus for processing a medical image based on a neural network, in which a small bowel region is classified from medical images acquired by capsule endoscopy, includes: a memory loaded with an organ classification algorithm to perform organ classification for the medical image; and a processor configured to classify the small blow region by applying the medical image to the organ classification algorithm, the organ classification algorithm including: a convolutional neural network algorithm configured to distinguish the small bowel region by classifying organs contained in the medical image into a stomach, a small bowel and a colon; and a temporal filtering algorithm linked to the convolutional neural network algorithm and configured to reduce images misclassified by the convolutional neural network algorithm.

The convolutional neural network algorithm may include a ResNet model trained with 2D images, and the temporal filtering algorithm may include a hybrid time filter that includes a Savitzky-Golay filter and a median filter.

In training the convolutional neural network algorithm, 3-class labeling for the stomach, the small bowel and the colon may be performed by reading a plurality of 2D images, and a training set may be made with the plurality of labelled 2D images and the convolutional neural network algorithm may be trained based on the training set so that the convolutional neural network algorithm can predict the small bowel region.

In training the convolutional neural network algorithm, the plurality of labeled 2D images may be sorted into the training set, a validation set, and a test set through random selection after the labeling, and each of the sorted sets may include both normal data and abnormal data.

In training the convolutional neural network algorithm, a 2D image ratio of the stomach, the small bowel and the colon may be adjusted to 1:2:1 to adjust imbalance among the organs.

In adjusting the 2D image ratio, normal and abnormal stomach images may be augmented by applying horizontal and vertical flips thereto; and normal and abnormal small bowel images and normal and abnormal colon images may be downsampled at preset ratios.

The downsampling may include: downsampling the normal small bowel and colon images at ratios of 2/3 and 1/3, respectively; and downsampling the abnormal small bowel and colon images at ratios of 3/4 and 3/7, respectively.

In training the convolutional neural network algorithm, the convolutional neural network algorithm may be validated based on the validation set after training the convolutional neural network algorithm.

The neural network-based medical image processing apparatus may test the convolutional neural network algorithm and the temporal filtering algorithm based on the test set after training the convolutional neural network algorithm.

In applying the temporal filtering algorithm, binary classification is performed.

The binary classification may include: applying the small bowel class acquired by the convolutional neural network algorithm to the Savitzky-Golay filter and the median filter; and distinguishing between frames of the small bowel and frames of the stomach and colon by mapping values greater than 1, which are obtained by adding and dividing result values of the Savitzky-Golay filter and the median filter, to 1 and mapping the obtained values less than 0 to 0.

The organ classification algorithm may predict organ changing frames from the medical images to classify the small bowel region.

The organ classification algorithm may be configured to: apply the small bowel class acquired by the convolutional neural network algorithm to the temporal filtering algorithm to designate a temporally filtered probability as a threshold; and distinguish between frames of the small bowel and frames of the stomach and colon based on the threshold.

The threshold may be 0.87.

The temporal filtering algorithm may correct a class probability of frames based on an organ probability derived from adjacent frames by the convolutional neural network algorithm.

Meanwhile, according to an embodiment of the disclosure, a method of processing a medical image based on a neural network, in which a small bowel region is classified from medical images acquired by capsule endoscopy includes: inputting the medical images to an organ classification algorithm; and classifying the small blow region from the medical images by the organ classification algorithm, the organ classification algorithm including: a convolutional neural network algorithm configured to distinguish the small bowel region by classifying organs contained in the medical image into a stomach, a small bowel and a colon; and a temporal filtering algorithm linked to the convolutional neural network algorithm and configured to reduce images misclassified by the convolutional neural network algorithm.

### Advantageous Effects

According to the disclosure, an apparatus and method for processing a medical image based on a neural network has an effect on significantly shortening a clinician's reading time because only small bowel images are automatically acquired through organ classification, thereby

Further, according to the disclosure, an apparatus and method for processing a medical image based on a neural network are capable of identifying starting and ending regions of a small bowel with high accuracy, thereby having great advantages when combined with other technologies for diagnosing a lesion in the small bowel.

The technical effects of the disclosure are not limited to the aforementioned effects, and other unmentioned technical effects may become apparent to those skilled in the art from the following description.

### DESCRIPTION OF DRAWINGS

FIG. 1 is a schematic diagram of a neural network-based medical image processing apparatus according to an embodiment,

FIG. 2 is a flowchart schematically showing a training method and a test method of an organ classification algorithm in a neural network-based medical image processing apparatus according to an embodiment,

FIG. 3 is a flowchart showing a detection process of an organ classification algorithm in a neural network-based medical image processing apparatus according to an embodiment,

FIG. 4 is a conceptual diagram showing results of an organ classification algorithm in a neural network-based medical image processing apparatus according to an embodiment,

FIG. 5a and FIG. 5b shows data resulting from analyzing an organ classification algorithm with gradient-weighted class activation mapping in a neural network-based medical image processing apparatus according to an embodiment,

FIG. 6 shows errors in transition from stomach to small bowel and transition from small bowel to colon in an organ classification algorithm of a neural network-based medical image processing apparatus according to an embodiment, and

FIG. 7 is a flowchart showing a neural network-based medical image processing method according to an embodiment.

### MODE FOR INVENTION

Hereinafter, embodiments of the disclosure will be described in detail with reference to the accompanying drawings. However, the disclosure is not limited to the embodiments set forth herein, but may be implemented in various different ways. The embodiments are provided to only complete the disclosure and allow those skilled in the art to understand the category of the disclosure. In the accompanying drawings, the shape, etc. of an element may be exaggerated for clear description, and like numerals refer to like elements.

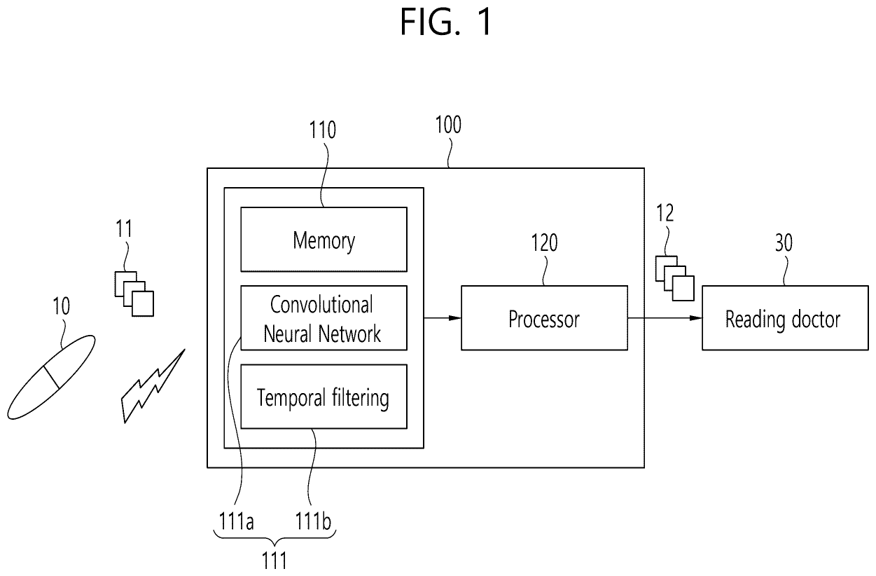

FIG. 1 is a schematic diagram of a neural network-based medical image processing apparatus according to an embodiment.

As shown in FIG. 1, the neural network-based medical image processing apparatus 100 according to an embodiment (hereinafter referred to as a ‘processing apparatus’) may predict organ changing frames from medical images 11 taken by a wireless capsule endoscope 10, thereby providing only small bowel images 12, which are subject to analysis, to a reading doctor 30. In this case, the medical images 10 may include images provided in real time from the wireless capsule endoscope 10, or pre-stored images provided from a database (not shown).

The processing apparatus 100 may classify the medical images 11 into three sections: a stomach, a small bowel and a colon, and provide only a small bowel image 12 to the reading doctor 30. Conventionally, the medical images could be classified into four sections: an esophagus, a stomach, a small bowel and a colon. However, when organ classification for the medical images 11 is performed in four sections, data imbalance occurs due to an insufficient number of learning data, thereby deteriorating the performance of algorithm. Therefore, the processing apparatus 100 may perform the organ classification in three sections excluding the esophagus section. In this case of the organ classification in three sections, the processing apparatus 100 may figure out a starting region and ending region of the small bowel based on a landmark on a boundary between the stomach and the small bowel and a landmark on a boundary between the small bowel and the colon.

To this end, the processing apparatus 100 may include a memory 110 and a processor 120.

The memory 110 is loaded with an organ classification algorithm 111 to perform the organ classification for the medical images 11. In addition, the processor 120 may selectively extract the small bowel images 12 from the medical images 11 by inputting the medical images 11 to the organ classification algorithm 111.

First, the organ classification algorithm 111 provided in the processing apparatus 100 may be based on a combination of a 2D convolutional neural network (CNN) algorithm 111a and a temporal filtering algorithm 111b. The organ classification algorithm 111 may be trained with images other than images. Below, methods of training and designing the organ classification algorithm 111 will be described in detail with reference to the accompanying drawings.

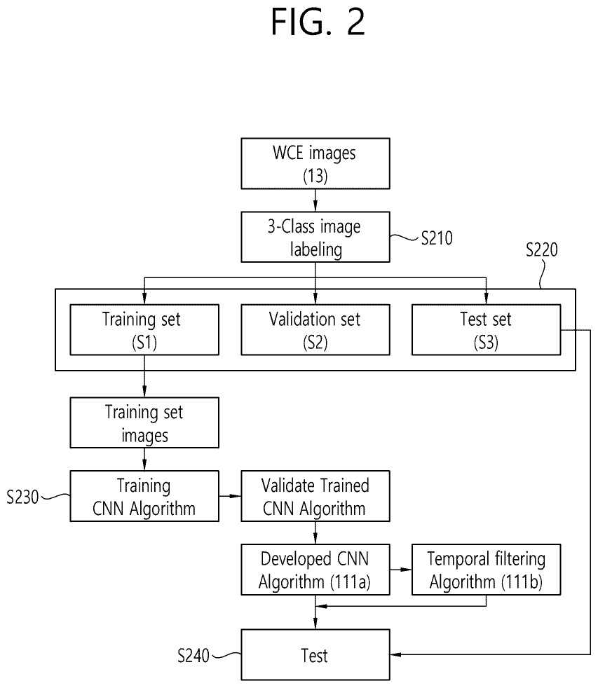

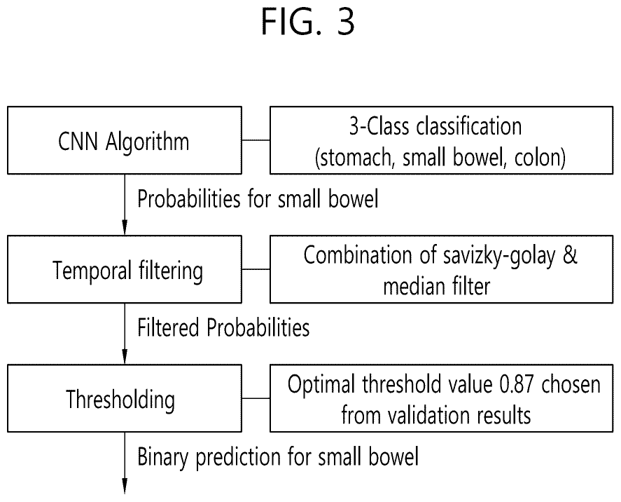

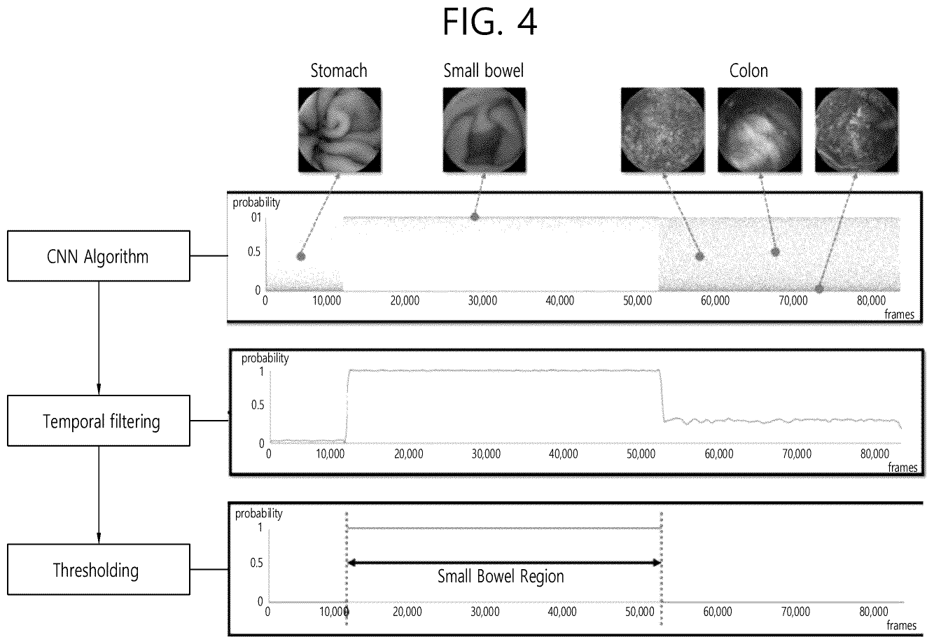

FIG. 2 is a flowchart schematically showing a training method and a test method of an organ classification algorithm in a neural network-based medical image processing apparatus according to an embodiment. In addition, FIG. 3 is a flowchart showing a detection process of an organ classification algorithm in a neural network-based medical image processing apparatus according to an embodiment, and FIG. 4 is a conceptual diagram showing results of an organ classification algorithm in a neural network-based medical image processing apparatus according to an embodiment.

As shown in FIGS. 2 to 4, wireless capsule endoscope (WCE) images 13 captured by the wireless capsule endoscope 10 may be used in training and designing the organ classification algorithm 111 according to an embodiment. However, this is merely for describing this embodiment and there are no limits to the type of learning data. Here, the WCE images 13 may be provided in a joint photographic experts group (JPEG) format having a matrix size of 320*320 and 3 frames per second (FPS).

Then, to train and design the organ classification algorithm 111, image labeling is performed for each organ (S210). In the image labeling, a reading doctor may perform 3-class labeling for the stomach, the small bowel and the colon by manually reading all the WEC images 13 to be read. Then, the labeling-completed WEC images are sorted into a training set S1, a validation set S2 and a test set S3 (S220). Random selection may be applied to image sorting. In this case, each of the sets S1, S2 and S3 may include both normal and abnormal data.

Then, to train and design the organ classification algorithm 111, the 2D convolutional neural network algorithm 111a is trained with the training set S1 (S230).

The 2D convolutional neural network algorithm 111a may refer to an algorithm that predicts the probability of a small bowel region. The 2D convolutional neural network algorithm 111a is trained to distinguish the stomach, the small bowel and the colon while using the ResNet50 model as a backbone network.

In this case, to adjust imbalance among the organs, data augmentation or downsampling may be performed so that a ratio of the stomach, small bowel and colon images can be 1:2:1. For example, the stomach images of normal and abnormal patients may be augmented by two times through horizontal and vertical flips. In addition, the small bowel and colon images of the normal patient may be downsampled at ratios of 2/3 and 1/3, respectively, and the small bowel and colon images of the abnormal patient may be downsampled at ratios of 3/4 and 3/7, respectively. The 2D convolutional neural network algorithm 111a may be trained by the adaptive moment estimation (ADAM) optimizer with a cross-entropy loss at a learning rate of 0.001.

Meanwhile, when the training of the 2D convolutional neural network algorithm 111a is completed, the organ classification algorithm 111 classifies the stomach, small bowel and the colon from the medical images 11 of the wireless capsule endoscope 10. In other words, the organ classification algorithm 111 may predict the probability of the boundaries between the stomach, the small bowel and the colon to distinguish the small bowel.

Then, the organ classification algorithm 111 is designed to perform the temporal filtering algorithm 111b. The temporal filtering algorithm 111b may refer to a hybrid temporal filter as a combination of the Savitzky-Golay filter and the median filter. Thus, the temporal filtering algorithm 111b uses only the probability of the small bowel to distinguish the boundary between the small bowel and the stomach and the boundary between the small bowel and the colon by thresholding.

Further, the temporal filtering algorithm 111b may perform binary classification. The temporal filtering algorithm 111b may add the result values of the Savitzky-Golay filter and the median filter, divide them in half, map the obtained values greater than 1 to 1, and map the obtained values less than 0 to 0. Here, when the maximum value is less than 1, the values may be divided by the maximum value. For example, a filtering range may be set to 1,001 frames, and the small bowel, the stomach and the colon may be classified based on a threshold of 0.87 after applying the temporal filtering algorithm 111b. Here, the minimum index of the frame where the small bowel is predicted may be identified as the starting region of the small bowel, and the maximum index may be identified as the ending region of the small bowel.

In this way, the organ classification algorithm 111 may detect a transition point between the organs based on the neural network algorithm to which the temporal filtering algorithm 111b is applied. In other words, the organ classification algorithm 111 classifies the images into the stomach, small bowel and colon images through the 2D convolutional neural network algorithm 111a. Then, the organ classification algorithm 111 corrects the class probability of the frame based on the organ probability derived from the adjacent frames through the temporal filtering algorithm 111b, thereby significantly reducing the number of frames misclassified by the 2D convolutional neural network algorithm 111a.

In addition, the probability temporally filtered for the small bowel may be designated as a threshold, thereby distinguishing between the frames for the small bowel mapped to 1 and the frames for the stomach and colon mapped to 0. Thus, the organ classification algorithm 111 may detect the transition points of the boundaries between the organs having dependency on each other in the image frames, such as the boundary between the stomach and the small bowel and the boundary between the small bowel and the colon.

In this way, once the organ classification algorithm 111 is completely trained and designed, the organ classification algorithm 111 may be tested based on the test set S3 (S240).

For example, in the test of the organ classification algorithm 111, a gradient-weighted class activation map (hereinafter referred to as a ‘Grad-CAM’), which is an explainable model, may be applied to the ResNet50 model. The Grad-CAM may be extracted from a feature map for a predicted class, and then adjusted to an image size, i.e., 320*320 of the wireless capsule endoscope 10 and overlaid on an original image. Thus, in the test, the performance of the trained and designed organ classification algorithm 111 may be quantitatively analyzed in terms of accuracy, sensitivity, specificity, positive predictive values (PPV), and negative predictive values (NPN).

Hereinafter, the results of the 3-class classification in the application of the organ classification algorithm according to an embodiment will be described in detail with reference to the accompanying drawings.

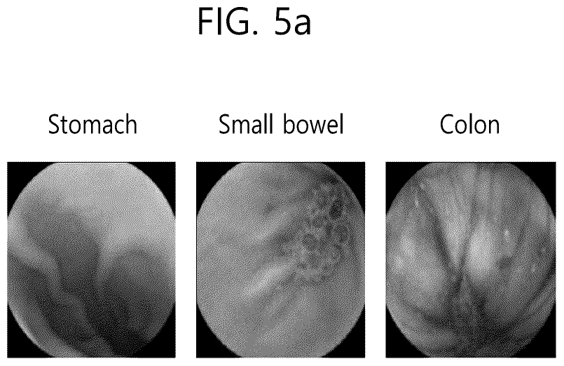

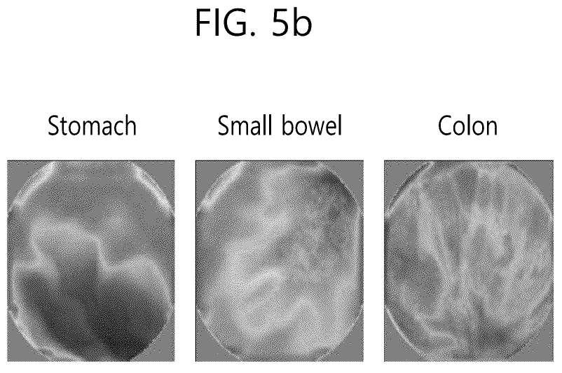

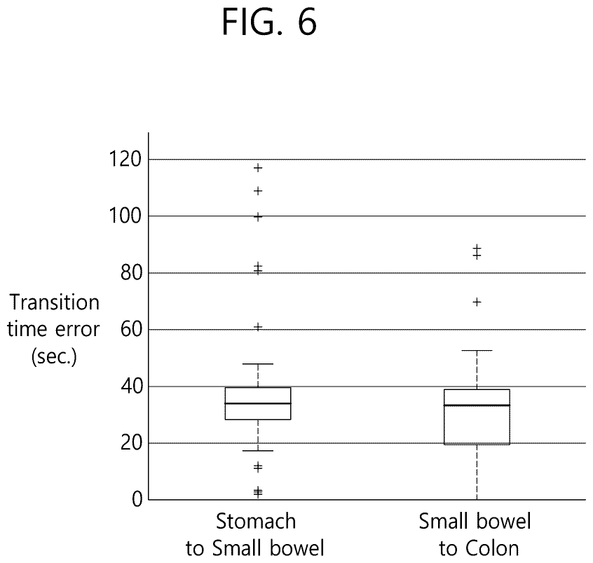

FIG. 5a and FIG. 5b shows data resulting from analyzing an organ classification algorithm with gradient-weighted class activation mapping in a neural network-based medical image processing apparatus according to an embodiment, and FIG. 6 shows errors in transition from stomach to small bowel and transition from small bowel to colon in an organ classification algorithm of a neural network-based medical image processing apparatus according to an embodiment.

As shown in FIGS. 5a, 5b and 6, as a result of analyzing the organ classification algorithm 111 according to this embodiment using the Grad-CAM, the color map in FIG. 5a and FIG. 5b represents a normalized prediction with red and blue referring to 1 and 0, respectively.

Here, comparison between FIGS. 5A and 5B shows that the result of applying the organ classification algorithm 111 according to an embodiment is similar to that from an endoscopist's organ classification process. In other words, it was confirmed that the trained and designed organ classification algorithm 111 classified the organs through structural information such as dark regions and mucosal vascular patterns captured along wrinkle and track directions.

Further, it was confirmed that the organ classification algorithm 111 according to an embodiment had higher performance than those of the prior art.

TABLE 1

| | Overall | Small bowel | | | | |
|---|---|---|---|---|---|---|
| Method | accuracy | accuracy | sensitivity | specificity | PPV | NPV |
| Prior Art | 75.10% | 78.80% | 92.13% | 75.09.% | 78.76% | 78.89% |
| ResNet50 | 88.00% | 88.47% | 94.22% | 85.00% | 85.48% | 92.65% |
| Prior Art + | — | 97.90% | 98.79% | 96.94% | 97.32% | 98.61% |
| temporal | | | | | | |
| filter | | | | | | |
| ResNet50 + | — | 99.80% | 99.60% | 99.80% | 99.98% | 99.55% |
| temporal | | | | | | |
| filter | | | | | | |

As shown in Table 1 above, compared to the prior art, the organ classification algorithm 111 according to an embodiment exhibits high performance based on a combination of the 2D convolutional neural network algorithm 111a of the ResNet50 model and the temporal filtering algorithm 111b.

Further, as a result of analyzing the randomly selected cases in the test set S3, it was confirmed that the temporal filtering algorithm 111b had a strong effect on distinguishing the small bowel that is subject to analysis. In particular, it was confirmed that the images misclassified by the 2D convolutional neural network algorithm 111a were significantly reduced after applying the temporal filtering algorithm 111b. In addition, the problem of many misclassified frames in the colon region was solved by deriving an appropriate threshold of 0.87, thereby making it possible to distinguish between the small bowel and the colon.

Further, a time error was calculated as a frame error for each case in units of FPS, a transition error between the stomach and the small bowel was merely 38.8±25.8 seconds, and a transition error between the small bowel and the colon was merely 32.0±19.1 seconds. Therefore, the transition time error of the organ classification algorithm 111 was very low.

Meanwhile, a method of processing medical images to be processed will be described in detail with reference to the accompanying drawings.

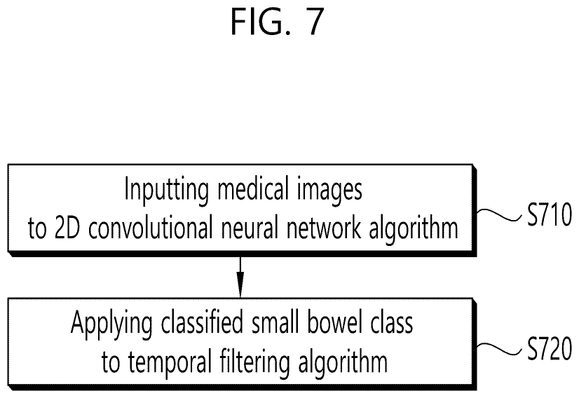

FIG. 7 is a flowchart showing a neural network-based medical image processing method according to an embodiment.

As shown in FIG. 7, in the image processing method according to an embodiment, the organ classification algorithm 111 is loaded into the memory 110.

Then, when the medical images 11 to be processed are provided from the outside to the processing apparatus 100, the processor 120 may perform the organ classification by applying the medical images 11 to be processed to the organ classification algorithm 111. Thus, the organ classification algorithm 111 may automatically classify and provide only the small bowel frames to the reading doctor 30.

In more detail, the processor 120 inputs the medical images 11 to be processed into the organ classification algorithm 111 (S710). Thus, the organ classification algorithm 111 may input the medical images 11 to be processed into the 2D convolutional neural network algorithm, thereby classifying the stomach, the small bowel and the colon based on the ResNet50 model.

In addition, the processor 120 applies the classified small bowel class to the temporal filtering algorithm 111 with the Savitzky-Golay filter and the median filter (S720). Thus, the boundary between the stomach and the small bowel and the boundary between the small bowel and the colon may be distinguished by thresholding.

Then, the processor 120 may provide the small bowel images 12, which are classified by the organ classification algorithm 111 and subject to analysis, to the reading doctor 30.

However, according to an embodiment, the processor 120 directly transmits the small bowel images 13 classified by the organ classification algorithm 111 to the reading doctor 30. However, this is merely to describe an embodiment, and the organ classification algorithm 111 may be linked to another algorithm for subsequent processing, for example, for identifying a lesion region, so that a lesion can be detected in the small bowel.

In this way, in an apparatus and method for processing a medical image based on a neural network according to the disclosure, only small bowel images are automatically acquired through organ classification, thereby having an effect on significantly shortening a clinician's reading time.

Further, in an apparatus and method for processing a medical image based on a neural network according to the disclosure, starting and ending regions of a small bowel are identified with high accuracy, thereby having great advantages when combined with other technologies for diagnosing a lesion in the small bowel.

Although a few embodiments of the disclosure have been described above and illustrated in the accompanying drawings, the embodiments should not be construed as limiting the technical spirit of the disclosure. The scope of the disclosure is limited only by the subject matters disclosed in the appended claims, and the technical spirit of the disclosure may be modified and changed in various forms by a person having ordinary knowledge in the art. Therefore, such modification and change obvious to those skilled in the art will fall within the scope of the disclosure.

1. An apparatus for processing a medical image based on a neural network, in which a small bowel region is classified from medical images acquired by capsule endoscopy, the apparatus comprising:
a memory loaded with an organ classification algorithm to perform organ classification for the medical image; and
a processor configured to classify the small blow region by applying the medical image to the organ classification algorithm,
the organ classification algorithm comprising:
a convolutional neural network algorithm configured to distinguish the small bowel region by classifying organs contained in the medical image into a stomach, a small bowel and a colon; and
a temporal filtering algorithm linked to the convolutional neural network algorithm and configured to reduce images misclassified by the convolutional neural network algorithm.

2. The apparatus of claim 1, wherein
the convolutional neural network algorithm comprises a ResNet model trained with 2D images, and
the temporal filtering algorithm comprises a hybrid time filter that comprises a Savitzky-Golay filter and a median filter.

3. The apparatus of claim 2, wherein, in training the convolutional neural network algorithm,
3-class labeling for the stomach, the small bowel and the colon is performed by reading a plurality of 2D images, and
a training set is made with the plurality of labelled 2D images, and the convolutional neural network algorithm is trained based on the training set so that the convolutional neural network algorithm can predict the small bowel region.

4. The apparatus of claim 3, wherein, in training the convolutional neural network algorithm,
the plurality of labeled 2D images are sorted into the training set, a validation set, and a test set through random selection after the labeling, and
each of the sorted sets comprises both normal data and abnormal data.

5. The apparatus of claim 4, wherein, in training the convolutional neural network algorithm,
a 2D image ratio of the stomach, the small bowel and the colon is adjusted to 1:2:1 to adjust imbalance among the organs.

6. The apparatus of claim 5, wherein, in adjusting the 2D image ratio,
normal and abnormal stomach images are augmented by applying horizontal and vertical flips thereto; and
normal and abnormal small bowel images and normal and abnormal colon images are downsampled at preset ratios.

7. The apparatus of claim 6, wherein the downsampling comprises:
downsampling the normal small bowel and colon images at ratios of 2/3 and 1/3, respectively; and
downsampling the abnormal small bowel and colon images at ratios of 3/4 and 3/7, respectively.

8. The apparatus of claim 4, wherein, in training the convolutional neural network algorithm,
the convolutional neural network algorithm is validated based on the validation set after training the convolutional neural network algorithm.

9. The apparatus of claim 4, wherein, after training the convolutional neural network algorithm,
the convolutional neural network algorithm and the temporal filtering algorithm are tested based on the test set.

10. The apparatus of claim 2, wherein, in applying the temporal filtering algorithm, binary classification is performed.

11. The apparatus of claim 10, wherein the binary classification comprises:
applying the small bowel class acquired by the convolutional neural network algorithm to the Savitzky-Golay filter and the median filter; and
distinguishing between frames of the small bowel and frames of the stomach and colon by mapping values greater than 1, which are obtained by adding and dividing result values of the Savitzky-Golay filter and the median filter, to 1 and mapping the obtained values less than 0 to 0.

12. The apparatus of claim 1, wherein the organ classification algorithm predicts organ changing frames from the medical images to classify the small bowel region.

13. The apparatus of claim 1, wherein the organ classification algorithm is configured to:
apply the small bowel class acquired by the convolutional neural network algorithm to the temporal filtering algorithm to designate a temporally filtered probability as a threshold; and
distinguish between frames of the small bowel and frames of the stomach and colon based on the threshold.

14. The apparatus of claim 13, wherein the threshold is 0.87.

15. The apparatus of claim 1, wherein the temporal filtering algorithm corrects a class probability of frames based on an organ probability derived from adjacent frames by the convolutional neural network algorithm.

16. A method of processing a medical image based on a neural network, in which a small bowel region is classified from medical images acquired by capsule endoscopy, the method comprising:
inputting the medical images to an organ classification algorithm; and
classifying the small blow region from the medical images by the organ classification algorithm,
the organ classification algorithm comprising:
a convolutional neural network algorithm configured to distinguish the small bowel region by classifying organs contained in the medical image into a stomach, a small bowel and a colon; and
a temporal filtering algorithm linked to the convolutional neural network algorithm and configured to reduce images misclassified by the convolutional neural network algorithm.
